(19) United States
(12) Patent Application Publication
(10) Pub. No.: US 2003/0009614 A1
(43) Pub. Date: Jan. 9, 2003

(54) Method for selecting an expansion device in a computer unit, a circuit board, and a computer

(75) Inventors: Kazuo Fujii, Yokohama-shi (JP); Takayuki Katok, Yokohama-shi (JP); Hideshi Tsukamoto, Tokyo-to (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/180,862

(22) Filed: Jun. 26, 2002

(30) Foreign Application Priority Data
Jul. 9, 2001 (JP) 2001-207906

(51) Int. Cl. G06F 13/36

(52) U.S. Cl. 710/306

(57) ABSTRACT

A computer unit wherein if mini PCI (Peripheral Component Interconnect) device 60 and CDC (Communication Daughter Card) 70 which have feature as modem have been accommodated as expansion devices, signals from I/O bridge 21 are sent to both mini PCI device 60 and the CDC 70, whereas signals from mini PCI device 60 are disconnected by bus switch 65 to allow only signals from CDC 70 to reach I/O bridge 21, and CDC 70 functions as modem.

### BACKGROUND OF THE INVENTION

1. Field of the Invention

The present invention relates to computer units and the like that have installed expansion devices which are used for communication, etc.

2. Background Art

In these years, PC's (Personal Computers) with high portability such as notebook PC have been widely used. Although this kind of notebook PC has various features on board, especially recently communication features such as modem, LAN (Local Area Network), or wireless LAN are required in order to enable sending/receiving data to and from the exterior via network. While these features can be added by implementing a device directly onto a mother board, they are generally added by installing so called daughter cards (also referred to as daughter boards) to the connector on a mother board for lower costs and shorter development time.

As the daughter cards, devices and the like which are connectable to a mini PCI (Peripheral Component Interconnect), are employed. For example, MDC (Mobile Audio/Modem Daughter Card), standardized by Intel. Corp., which has modem feature can be named. To these daughter cards, AC '97 (Audio CODEC '97) are generally applied as a specification of sound devices and modem devices for PCI bus. In a typical notebook PC, the bus for AC'97 (AC link) extending from an I/O bridge is two-channel, one channel assigned to the connector for a sound device and the other one to the connector for a modem device.

### SUMMARY OF THE INVENTION

It will be required to mount multiple communication devices when rendering communication feature more advanced one. Specifically, this is a case when it is desired that modems of two kinds which are different in feature from another are to be mounted and used by switching them depending on purposes. However, since a typical notebook PC has single connector for modem device in AC'97 as described above, it will be necessary to add a slot for a mini PCI for accommodating the modem and increase the number of connectors if another new modem is to be mounted.

But even in case a system had a multiple connectors which has AC'97 link connected, there would be a collision between the new modem and a one that is already incorporated for the use of AC'97 link.

Therefore, it is supposed that such a problem that the kind of device which can be newly added is limited could occur not only when a user incorporates two modems into a notebook PC, but if the device is a combined device having modem feature in conjunction, when newly incorporating a device intended for a wireless LAN etc., for example.

The present invention was made based on these technical problems and is intended mainly to provide a computer unit that, when accommodating multiple devices capable of processing common signals, can select one out of them which actually functions in a simple configuration.

It is therefore an object of the invention to have any one of modems function when multiple modems have been accommodated into a notebook computer.

For the purpose, the computer unit according to the invention comprises a plurality of communication processing portions capable of communicating with the exterior, an arithmetic processing portion capable of sending/receiving signals of communication data to and from the communication processing portions via signal lines, and a signal line selecting portion for selecting signal lines through which the signal passes from among a plurality of signal lines that send signals from each of the multiple communication processing portions to the arithmetic processing portion, characterized in that the arithmetic processing portion has a transmitter for sending the same signal to the plurality of communication processing portions, and also receives signals from either of signal lines that has been selected by the signal line selecting portion, among those signals sent from the plurality of communication processing portions.

Since in this computer unit those signals that are sent from the communication processing portion to the arithmetic processing portion are selected, it is possible to limit the communication processing portion out of a plurality of ones that communicates with the exterior. Here, modem, LAN or wireless LAN, for example, that have features of sending/receiving data to and from the exterior computers or external networks can be named as the communication processing portion capable of communicating with the exterior.

Also, the computer unit according to the invention can be viewed as being characterized in that it has an arithmetic processing portion, and a plurality of expansion devices that can process at least one common signal for the arithmetic processing portion via signal lines, wherein on down stream signal lines that extend from the arithmetic processing portion to the multiple expansion devices signals reach the multiple expansion devices, and on up stream signal lines that extend from multiple expansion devices to the arithmetic processing portion, signals sent from any one of the expansion devices reach the arithmetic processing portion. Here, it is possible to provide a signal gate portion on the up stream signal line, for example, to select signals that will reach.

Moreover, the computer unit according to the invention can also be viewed as characterized in that it has a plurality of connectors for accommodating a plurality of daughter cards, a plurality of serial data sending lines extending from each of the connectors, and an I/O bridge that sends/receives serial data to and from daughter cards, wherein the plurality of serial data sending lines are integrated before connecting to the I/O bridge, and the I/O bridge receives serial data sent from any one of the daughter cards.

In this computer unit, if daughter cards have a feature as modem, for example, sending/receiving of serial data is made according to an AC (Audio CODEC) standard such as AC'97. Examples of daughter card can be mini PCI (Peripheral Component Interconnect) cards or communication daughter cards.

Since the I/O bridge receives serial data sent from any one of the daughter cards, it is possible for example to provide a switch on a serial data sending line. This switch can be switched according to a designation signal from a GPO (General Purpose Out) line that extends from the I/O bridge to the switch.

Also, the invention can be considered as a circuit board that controls signals sent from the accommodating portions for expansion device to the arithmetic processor (controlling portion). Specifically, the followings can be named.

The circuit board according to the present invention is characterized in that it has an arithmetic processor, a first and a second accommodating unit for accommodating a first and a second expansion device, a first and a second signal line for sending signals from the first and the second accommodating unit to the arithmetic processor, a recognition unit for recognizing that an expansion device capable of processing signals that are common to the first expansion device has been accommodated in the second accommodating unit as the second expansion device, and a signal disconnecting unit for disconnecting the first or the second signal line depending on the recognition at the recognition unit.

Alternatively, the circuit board according to the invention has a plurality of expansion device accommodating portions, a controlling portion for the expansion devices, a plurality of up signal transmitting lines that send signals from the plurality of expansion device accommodating portions toward the controlling portion, and a plurality of down signal transmitting lines that send signals from the controlling portion toward the expansion device accommodating portions, characterized in that any one of the multiple up signal transmitting lines has continuity, and all of the down signal transmitting lines have continuity.

In addition, the circuit board according to the invention is characterized in that it has an arithmetic processing portion, one channel extending from the arithmetic processing portion that sends/receives signals according for instance to the AC'97 standard as an AC (Audio CODEC) standard, a plurality of modem card accommodating portions to which one channel connects by branching, and a switching portion provided on one channel, for switching the pass state of signals from the plurality of modem card accommodating portions to the arithmetic processing portion.

Moreover, the present invention may be considered as a method for selecting an expansion device in a computer. The method for selecting an expansion device is characterized in that it is recognized that a plurality of expansion devices which can send/receive at least one common signal to and from the arithmetic processing portion have been connected to the connector, down signals issued from the arithmetic processing portion are allowed to pass to be sent to the plurality of expansion devices, and up signals issued from any one of the plurality of expansion devices are selected and sent to the arithmetic processing portion.

In the method above, in order to select an expansion device to be used automatically, signals from the expansion device which is connected to a connector preset to be prior may be allowed to pass in sending up signal. In this case, the selection of signals can be made by recognizing ID signals that are sent from the expansion device connected to the connector which has been set prior.

Alternatively, a user may select an expansion device to be used. For a specific example, it is displayed to the user that a plurality of expansion devices have been connected, and a signal that specifies the expansion device selected by the user is sent to the signal selector, based on which signal the signal for the expansion device can be selected. In this case, the computer is preferably booted so that the designated expansion device might function effectively.

### BRIEF DESCRIPTION OF THE DRAWINGS

FIG. 1 illustrates the hardware configuration of computer system 10 in this embodiment;

FIG. 2 is a configuration diagram illustrating the signal processing between I/O bridge 21, and CDC 70 and mini PCI device 60 in the embodiment 1;

FIG. 3 is a flow diagram illustrating the flow of processing of signals in the embodiment 1;

FIG. 4 is a configuration diagram illustrating the signal processing between I/O bridge 21, and CDC 70 and mini PCI device 60 in the embodiment 2; and

FIG. 5 is a flow diagram illustrating the flow of processing of signals in the embodiment 2.

### DESCRIPTION OF THE PREFERRED EMBODIMENT

Embodiment 1

In the following, detailed description of the invention are set forth based on the embodiments shown in the accompanying drawings.

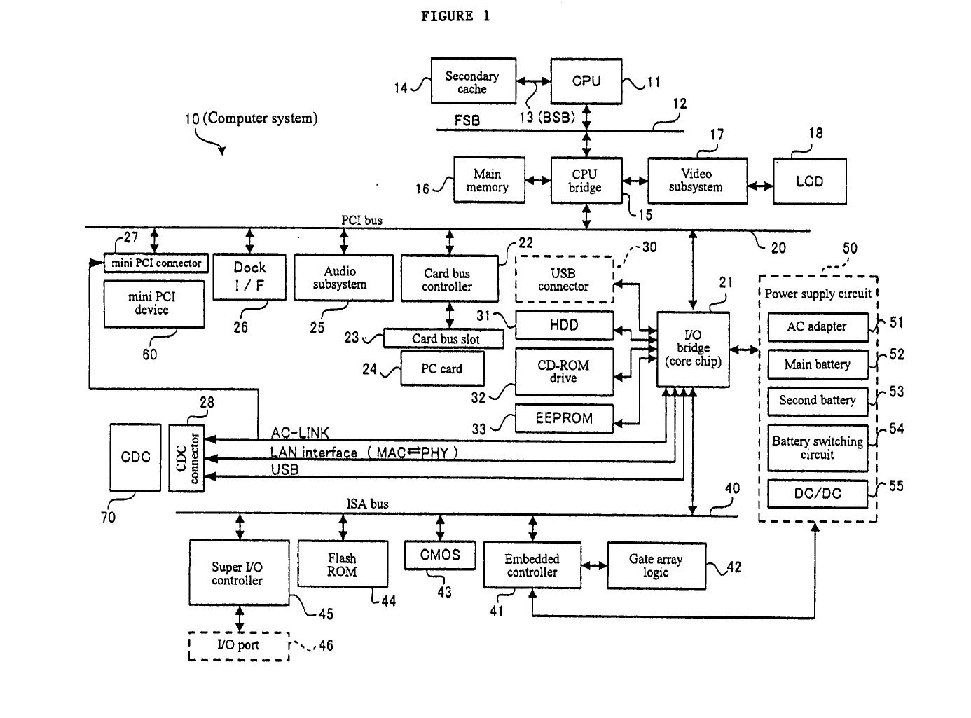

FIG. 1 shows the hardware configuration of the computer system (computer unit) 10 in this embodiment. A computer unit that comprises the computer system 10 is configured as a notebook PC (a notebook personal computer) that has aboard a predetermined OS (Operating System) in compliance with OADG (Open Architecture Developer's Group) specification, for example.

In the computer system 10 shown in FIG. 1, CPU (arithmetic processing portion, arithmetic processor) 11 functions as the brain of the entire computer system 10 and runs various programs under the control of the OS. CPU 11 is interconnected with each component through three-level buses; FSB (Front Side Bus) 12 that is a system bus, PCI (Peripheral Component Interconnect) bus 20 as a high speed bus for I/O devices, and ISA (Industry Standard Architecture) bus 40 as a low speed bus for I/O devices. For CPU 11, increase in processing speed is contemplated by storing program codes and data in a cache memory. Although SRAM of on the order of 128 KB has been integrated internally in the CPU 11 as a primary cache in recent years, a secondary cache 14 of about 512 KB to 2 MB is placed via BSB (Back Side Bus) 13 which is a dedicated bus, to compensate the shortage of capacity. As well, it is also possible to reduce costs by omitting BSB 13 and connecting the secondary cache 14 to FSB 12 to avoid a package with many terminals.

FBS 12 and PCI bus 20 are communicated by a CPU bridge (host-PCI bridge) 15 referred to as a memory/PCI chip. The CPU bridge 15 is configured such that it includes a memory controller feature for controlling access operation to the main memory 16, and a data buffer for absorbing the difference of data transfer rates between FSB 12 and PCI bus 20. Main memory 16 is a writable memory utilized as a reading area for execution programs of CPU 11, or as a work area to which processed data of the execution programs are written. For example, the memory may be configured with a number of DRAM chips and come with 128 MB, for example, and can be expanded up to 320 MB. The execution programs include various drivers for operating the OS and peripheral devices via hardware, application programs directed to particular operations, and firmware such as BIOS (Basic Input/Output system) stored in flash ROM 44 to be after-mentioned.

Video subsystem 17 is a subsystem for implementing features relating to video and includes a video controller. The video controller processes rendering instructions from CPU 11 and writes the processed rendering instructions to the video memory, as well as reads the rendering instructions from the video memory and outputs them as rendering data to liquid crystal display (LCD) 18.

PCI bus 20 is a bus capable of transferring data relatively fast and is standardized according to a specification that specifies data bus width as 32 bits or 64 bits, maximum operation frequency as 33 MHz or 66 MHz, and maximum data transfer rate as 132 MB/s or 528 MB/s. Connected respectively to PCI bus 20 are I/O bridge (core chip, arithmetic processing portion, arithmetic processor, controlling portion) 21, card bus controller 22, audio subsystem 25, docking station interface (Dock I/F) 26, and mini PCI connector (expansion device accommodating portion, modem card accommodating portion, a first accommodating unit) 27.

Card bus controller 22 is a dedicated controller for connecting the bus signal of PCI bus 20 directly to the interface connector (card bus) of card bus slot 23, on which PC card 24 may be mounted. The docking station interface 26 is a piece of hardware for connecting a docking station (not shown) which is a feature expansion device for computer system 10. When a notebook PC is set onto the docking station, various hardware elements that are connected to the internal bus of the docking station are connected to the PCI bus 20 through the docking station interface 26. Also, to the mini PCI connector 27 mini PCI device (expansion device, daughter card, modem card) 60 is connected. Mini PCI device 60 is an expansion card (board) that can be expanded in compliance with the specification for mini PCI. The mini PCI is a PCI standard for mobile and published as an appendix of PCI Rev. 2.2 specification. It is equivalent to full specification PCI in feature. Further, to mini PCI connector 27 the AC'97 link extending from I/O bridge 21 is connected.

I/O bridge 21 comprises bridge feature between PCI bus 20 and ISA bus 40. It also comprises DMA controller feature, programmable interruption controller (PIC) feature, programmable interval timer (PIT) feature, IDE (Integrated Device Electronics) interface feature, USB (Universal Serial Bus) feature, and SMB (System Management Bus) interface feature, as well as has a real time clock (RTC) built internally.

The DMA controller feature is a feature for performing data transfer between peripheral devices such as FDD and the main memory 16 without intervention of CPU 11. The PIC feature is a feature for running a predetermined program (interruption handler) in response to an interruption request (IRQ) from peripheral devices. The PIT feature is a feature for generating timer signals in a predetermined cycle. Also, the interfaces that are implemented by the IDE interface feature include in addition to IDE hard disc drive (HDD) 31 being connected, CD-ROM drive 32 being connected to ATAPI (AT Attachment Packet Interface). Other type of IDE device such as DVD (Digital Versatile Disc) drive may be connected instead of CD-ROM drive 32. The external storages such as HDD 31 or CD-ROM drive 32 are housed for example in a housing location called “media bay” or “device bay” in the notebook PC body. These standard-equipped external storages could be attached interchangeably with and exclusively to other equipments such as FDD or battery pack.

Also, the I/O bridge 21 is provided with an USB port, which is connected with the USB connector 30 provided for example on the wall of notebook PC body. Additionally, EEPROM 33 is connected to I/O bridge 21 through a SM bus. EEPROM 33 is a memory for retaining information such as passwords and supervisor passwords registered by users, or product serial numbers, and is nonvolatile and allows its stored contents to be electrically rewritten. Also, I/O bridge 21 is connected to the power supply circuit 50. Power supply circuit 50 comprises circuits such as AC adapter 51, battery switching circuit 54 that charges the main battery 52 or a second battery 53 as a battery (or a secondary battery) as well as switches the power supplying paths from AC adapter 51 or each battery, and DC/DC converter (DC/DC) 55 that generates DC constant voltage of 5V or 3.3V to be used at computer system 10.

Also connected to I/O bridge 21 is connector (expansion device accommodating portion, modem card accommodating portion, second accommodating unit) 28 for a daughter card (hereinafter referred to as a communication daughter card (CDC)) which has communication feature with the exterior, to which CDC (expansion device, daughter card, modem card) 70 is connected. CDC 70 is an expansion card (board) expandable in compliance with the AC'97 link specification, and has a size smaller than mini PCI device 60, an area of about 1/2.5 of mini PCI device 60, for example. Also, exchange of signals is made between CDC connector 28 and I/O bridge 21 based on the specification of AC'97 link. Between CDC connector 28 and I/O bridge 21 an analog interface such as Ethernet (R) and devices compliant with the USB specification can be accommodated other than AC'97 link, and devices for wireless LAN or Ethernet (R) may be connected to CDC connector 28.

Provided inside the core chip composing the I/O bridge 21 are an internal register for managing the power supply state of the computer system 10, and a logic (a state machine) to perform the management of the power supply state of computer system 10 including the operation of the internal register. The logic sends/receives various signals to and from power supply circuit 50 and by which recognizes the actual feeding state from power supply circuit 50 to computer system 10. Power supply circuit 50 controls the supply of electric power to computer system 10 depending on designations from the logic.

ISA bus 40 is a bus that has lower data transfer rate than PCI bus 20 (bus width being 16 bits and maximum data transfer rate 4 MB/s, for example). Connected to ISA bus 40 are embedded controller 41 connected to gate array logic 42, CMOS 43, flash ROM 44, and Super I/O controller 45. Furthermore, the bus is also used to connect a peripheral devices such as keyboard/mouse controller that operate at relatively low speed. I/O port 46 is connected to Super I/O controller 45, controlling driving of a FDD, input/output of parallel data via a parallel port, and input/output of serial data via a serial port (SIO). Embedded controller 41 not only controls a keyboard not shown, but is connected to power supply circuit 50 and responsible partly for the power supply managing feature along with the gate array logic 42 by means of a integrated power management controller (PMC).

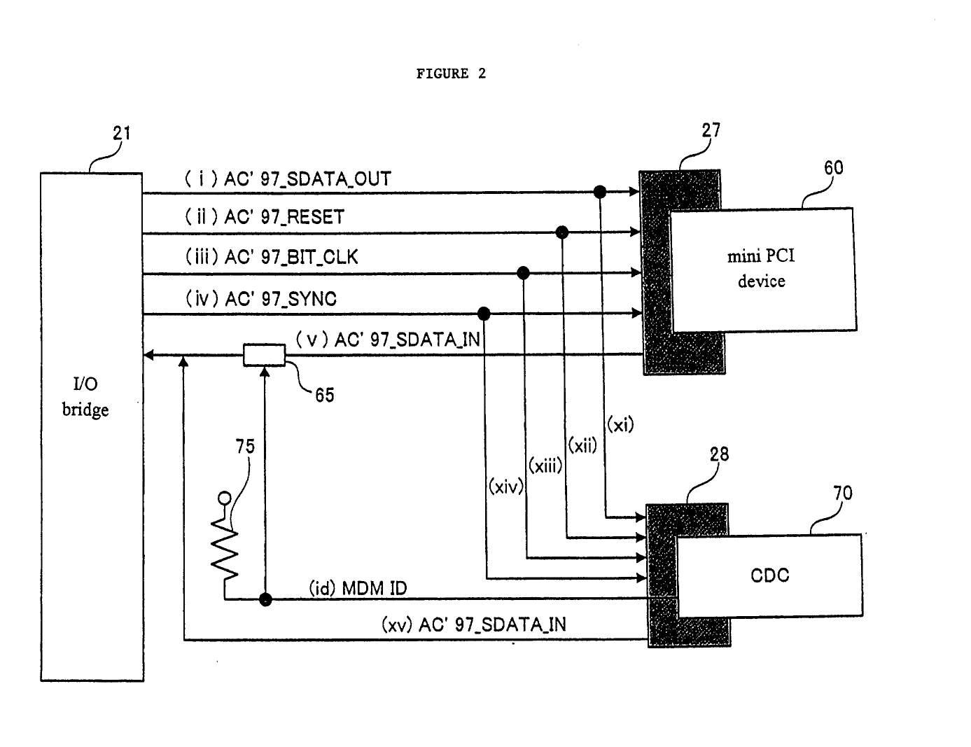

FIG. 2 is a configuration diagram illustrating processing of signals between I/O bridge 21, and CDC 70 and mini PCI device 60 in the embodiment 1.

Shown in the figure is a state that I/O bridge 21, mini PCI connector 27 and CDC connector 28 are provided on the same circuit board, mini PCI device 60 being connected to mini PCI connector 27 and CDC 70 to CDC connector 28.

As shown, a plurality of signal lines of AC'97 link (down stream signal lines) (i), (ii), (iii) and (iv) extending from I/O bridge 21 are communicated to mini PCI connector 27 to which mini PCI device 60 is connected. Moreover, these signal lines branch respectively on the way from I/O bridge 21 to mini PCI device 60 to become signal lines (down stream signal lines) (xi), (xii), (xiii) and (xiv), communicating to CDC connector 28 to which CDC 70 is connected. In other words, signals from I/O bridge 21 are sent in one direction on these signal lines (i), (ii), (iii), (iv), (xi), (xii), (xiii) and (xiv), and shared by mini PCI device 60 and CDC 70. The types of signals sent on the signal lines (i), (ii), (iii), (iv), (xi), (xii), (xiii) and (xiv) are as the following.

On the signal lines (i) and (xi), signal of AC'97_SDATE_OUT is sent. AC'97_SDATE_OUT is serial data of AC'97 from an AC'97 compliant controller to all of the AC'97 compliant codecs on the link.

On the signal lines (ii) and (xii), signal of AC'97_RESET is sent. AC'97_RESET is serial data of AC'97 from the AC'97 compliant codec to the AC'98 compliant controller.

On the signal lines (iii) and (xiii), signal of AC'97_BIT_CLK is sent. AC'97_BIT_CLK is serial data clock from a primary codec to the AC'97 controller and a secondary codec. In synchronization of the AC'97 link, frequency of about 12 Hz is typically used as the frequency of this signal.

On the signal lines (iv) and (xiv), signal of AC'97_SYNC is sent. AC'97_SYNC is a synchronization pulse signal from the AC'97 compliant controller to all of the AC'97 compliant codecs on the link. This signal has an usually 1.3 us wide pulse for use in synchronization of AC'97 link.

Meanwhile, for mini PCI device 60, signal line (up stream signal line, serial data sending line, first signal line) (v) extends from mini PCI connector 27 to I/O bridge 21. Also, for CDC 70 signal line (up stream signal line, serial data sending line, second signal line) (xv) extends from CDC connector 28 to I/O bridge 21. On these signal lines (v) and (xv), signal of AC'97_SDATE_IN is sent in one direction from mini PCI connector 27 or CDC connector 28 to I/O bridge 21. The AC'97_SDATE_IN is serial data of AC'97 from the AC'97 compliant controller to the AC'97 compliant codecs.

Also, bus switch (signal line selecting portion, signal gate portion, switching unit, switching portion, signal selector) 65 is provided on the signal line (v) extending from mini PCI. connector 27 to I/O bridge 21. It is characteristic that the propagation delay time that a signal passes the bus switch is very short (about several tenth nanoseconds). Other options are possible as bus switch 65 other than the above as long as it can be switched, and low-voltage standard logic IC, etc. can be used for example, however, its propagation delay time is preferably short.

Also, to bus switch 65 a signal line (id) extending from CDC connector 28 is connected. The signal line (id) (: recognition unit) sends identification signal indicating CDC 70 inserted to CDC connector 28. As well, resistor 75 is connected to the line (id).

A method for processing signals at I/O bridge 21, CDC 70 and mini PCI device 60 will be now described. In the description a case is assumed where mini PCI device 60 which has a feature as modem has been connected beforehand to mini PCI connector 27 and is functioning as modem, and then CDC 70 which has a feature as modem is newly connected to CDC connector 28. For example, this can be the case when a mini PCI being already attached to an off-the-shelf PC, and CDC 70 is to be introduced as modem with new features, or CDC 70 is to be introduced which has multiple features such as wireless LAN and modem.

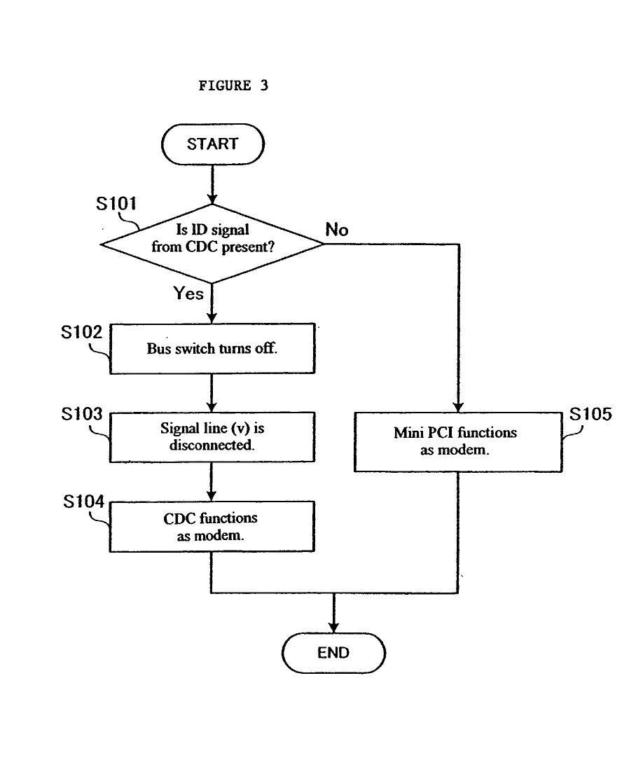

FIG. 3 is a flow chart illustrating the flow of processing of signals in the embodiment 1. Initially, bus switch 65 determines whether an ID signal from CDC 70 is present (step S101). Specifically, when CDC 70 is connected to CDC connector 28, CDC 70 sends an ID signal (MDM ID) from the line (id) to bus switch 65 for informing that it is a modem. If bus switch 65 receives an ID signal sent in this way and it is determined at step S101 that an ID signal is present, bus switch 65 turns off (step S102).

Once bus switch 65 has turned off, the signal line (v) extending from mini PCI device 60 to I/O bridge 21 is disconnected to disable sending signals (step S103). As a result, only those signals sent from the signal line (xv) extending from CDC connector 28 of CDC 70 will reach I/O bridge 21 as serial data sent from the devices, and CDC 70 functions as modem (step S104).

On the other hand, if it is determined that there is no ID signal from CDC 70 at step S101, in other words when CDC 70 is not plugged into CDC connector 28, or when CDC 70 plugged into CDC connector 28 does not function as modem, only those signals sent from the signal line (v) extending from mini PCI connector 27 will reach I/O bridge 21, and mini PCI device 60 functions as modem.

In the above embodiment 1, the signals from I/O bridge 21 are sent to both of the signal lines (i) and (xi), (ii) and (xii), (iii) and (xiii), and (xiv) and (iv). On the other hand, as for the signals sent from mini PCI device 60 and CDC 70, since pass of signals on either the signal line (v) or (xv) is disconnected by bus switch 65, signals sent from either of mini PCI device 60 or CDC 70 will reach I/O bridge 21. Therefore, such a problem will never occur that signals from multiple devices i.e., both of mini PCI device 60 and CDC 70 will reach I/O bridge 21 to lead to disorder in processing at I/O bridge 21 or CPU 11. In this manner, a device that actually operates as modem is set to either mini PCI device 60 or CDC 70. Although signals are sent from I/O bridge 21 to multiple devices, i.e., to both of mini PCI device 60 and CDC 70, problems would not occur because a device that will actually function is selected.

As such it is possible to make a modem function without causing collisions of data or any trouble on the AC'97 link, because in this embodiment modems which actually functions can be limited to one among a plurality of ones introduced. Consequently, if CDC 70 is to be introduced as a new device, for example, a user can freely select the type of device to be introduced because CDC connector 28 may introduce CDC 70 whether it has modem feature or not.

Furthermore, in the embodiment it is possible to choose with ease one modem from among a plurality of ones and have it function, in a simple configuration of providing a switch for switching only the signals from the device as modem. Therefore, circuit boards on which I/O bridge 21, mini PCI connector 27, and CDC connector 28 will be provided can be easily manufactured, and its size also may be made smaller.

If a connector that accommodates multiple modems has been connected on the AC'97 link, it is possible to provide switches on all the signal lines that compose the AC'97 link to make any one of the connected modems function, however, by providing a switch only on the signal line sent from the modem side as in the above embodiment 1, cost and the size of circuit board could be reduced because fewer switches need to be provided compared to a case where every signal line are provided with switches.

In the above embodiment, a case was described where mini PCI device 60 has been already introduced and CDC 70 is to be newly introduced, however, it may be the reverse, i.e., the invention may be applied when CDC 70 has been already introduced and mini PCI device 60 will be newly added. Besides, the invention is applicable when a CDC other than CDC 70 is provided instead of mini PCI device 60, or when more than two devices are to be introduced.

Also, in the above embodiment CDC 70 has been set to be prior to mini PCI device 60 and will be automatically selected as modem upon the introduction of CDC 70, however, it is also possible to set mini PCI device 60 to be prior in reverse. In either case, any one of the modems is enabled to function normally by selecting signals that are sent from any one of the modems from among signals sent from multiple modems to I/O bridge 21.

Embodiment 2

In the signal processing of embodiment 1, a case was described where CDC 70 automatically functions as modem when CDC 70 is connected to CDC connector 28. In the signal processing of embodiment 2, a user selects which of mini PCI device 60 and CDC 70 will be used as modem. Like symbols will be used for like configurations as the embodiment 1, whose detailed description is omitted.

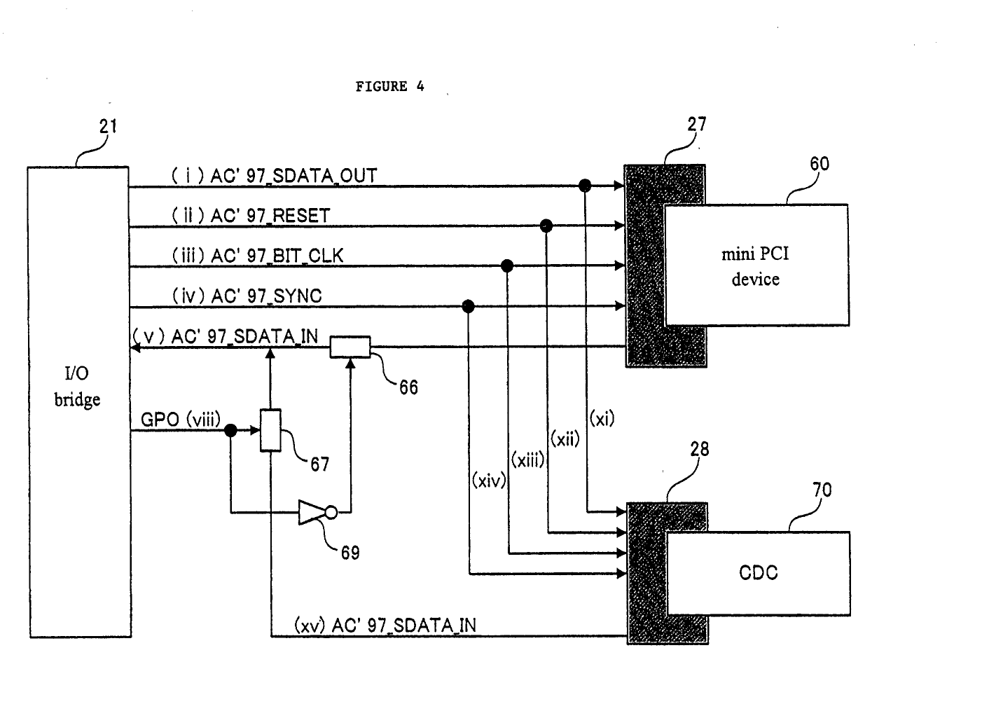

FIG. 4 is a configuration diagram illustrating the signal processing between I/O bridge 21, and CDC 70 and mini PCI device 60 in the embodiment 2.

The embodiment 2 shown is different from the embodiment 1 in that a first bus switch 66 is provided on the signal line (v) extending from mini PCI connector 27 to I/O bridge 21 and a second bus switch 67 is provided on the signal line (xv) connecting from CDC connector 28 to the signal line (v), GPO signal line (viii) extending from I/O bridge 21 branches to be connected to the first and second bus switches 66, 67 respectively, and NOT circuit 69 is provided on the GPO signal line (viii) branching to the first bus switch 66.

The method for processing signals in the embodiment 2 will be now described. In the embodiment 2, if mini PCI device 60 which has a feature as modem is connected to mini PCI connector 27, and CDC 70 which as well has a feature as modem is connected to CDC connector 28, it will be possible for a user of the notebook PC to select which of mini PCI device 60 and CDC 70 will be used as modem and make either selected device function.

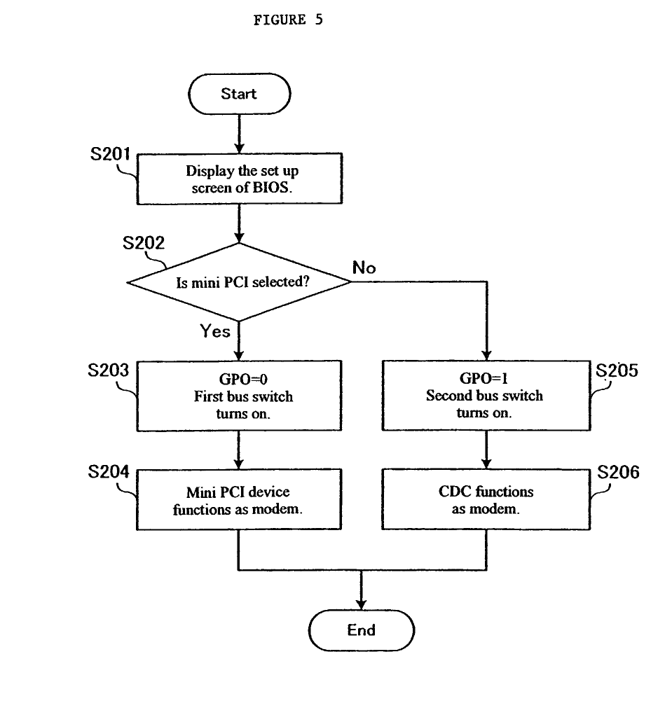

FIG. 5 is a flow diagram illustrating the flow of signal processing in the embodiment 2.

Initially, the set up screen of BIOS (Basic Input/Output System) of PC is displayed on a display not shown in response to an user's request (step S201). A device is selected on the displayed set up screen that the user wants to use as modem. Then it is determined whether mini PCI device 60 has been selected (step S202).

If it has been determined in step S202 that mini PCI device 60 was selected by the user, a signal with GPO (General Purpose Out) being “0” is sent from I/O bridge 21 to the GPO signal line (viii), and the signal “0” is inverted by NOT circuit 69 to be a signal “1”. Then the signal “1” reaches the first bus switch 66, causing the first bus switch 66 to turn on (step S203). At this time, although the signal “0” reaches from the GPO signal line (viii) to the second bus switch 67, the second bus switch 67 will remain off because the signal is “0”. After the first and the second switch 66, 67 have been set in this way, the computer system 10 will be booted. Then while the signal line (v) extending from mini PCI connector 27 turns valid, the signal line (xv) extending from CDC connector 28 turns invalid. As a result, mini PCI device 60 functions as modem (step S204).

On the other hand, if it is determined in step S202 that mini PCI device 60 has not been selected by the user, a signal with GPO (General Purpose Out) being “1” is sent from I/O bridge 21 to the GPO signal line (viii), and the second bus switch 67 turns on (step S205). Meanwhile, the signal “1” is inverted by NOT circuit 69 to become a signal “0”. Thus, the first bus switch 66 receiving the signal “0” will remain off. After setting the first and the second bus switch 66, 67 in this way, computer system 10 will be booted. Then while the signal line (xv) extending from CDC connector 28 turns valid, the signal line (v) extending from mini PCI connector 27 turns invalid. As a result, CDC 70 functions as modem (step S206).

In the embodiment 2 described above, providing the first bus switch 66 and the second bus switch 67 in the AC'97 link of computer system 10 allows a user to easily select a desired device as modem between two devices connected to the AC'97 link. Although in the embodiments 1 and 2 a case has been discussed where the two devices, i.e., mini PCI device 60 and CDC 70 are connected, the invention may be applied when more than two devices are connected.

Besides, it is possible to use some of the configurations set forth in the embodiment above, or to modify them properly into other configurations unless it departs from the subject matter of the invention.

Advantages of the Invention:

As described above, when multiple devices which have the same feature are accommodated, it is enabled to select one which actually functions from among them in a simple configuration according to the computer unit of the invention.

Description of symbols:

10 . . . computer system (computer unit)

11 . . . CPU (arithmetic processing portion, arithmetic processor)

20 . . . PCI (Peripheral Component Interface) bus

21 . . . I/O bridge (core chip, arithmetic processing portion, arithmetic processor, controlling portion)

27 . . . mini PCI connector (expansion device accommodating portion, modem card accommodating portion, first accommodating portion)

28 . . . CDC connector (expansion device accommodating portion, em card accommodating portion, second accommodating unit)

41 . . . embedded controller

50 . . . power supply circuit

51 . . . AC adapter

55 . . . DC/DC converter

60 . . . mini PCI device (expansion device, daughter card, modem card)

65, 66, 67 . . . bus switch (signal line selecting portion, signal gate portion, switching unit, switching portion, signal selector)

70 . . . CDC (expansion device, daughter card, modem card)

1. A computer unit comprising:
a plurality of communication processing portions capable of communicating with the exterior;
an arithmetic processing portion capable of sending/receiving signals of data for communication to and from said plurality of communication processing portions through signal lines; and
a signal line selecting portion which selects signal lines through which signals pass out of said plurality of signal lines that send signals from each of said plurality of communication processing portions to said arithmetic processing portion,
wherein said arithmetic processing portion has a transmitter for sending the same signal to said plurality of communication processing portions, and receives signals from either of the signal lines selected by said signal line selecting portion among signals sent from said plurality of communication processing portions.

2. A computer unit according to claim 1, wherein of said plurality of communication processing portions, a communication processing portion to which said selected signal line connects communicates with said exterior.

3. A computer unit, comprising:
an arithmetic processing portion; and
a plurality of expansion devices capable of processing at least one common signal for said arithmetic processing portion,
wherein on down stream signal lines extending from said arithmetic processing portion to said plurality of expansion devices, signals sent from the arithmetic processing portion reach the plurality of expansion devices,
and on up stream signal lines extending from said plurality of expansion devices to said arithmetic processing portion, signals sent from any one of said plurality of expansion devices reach said arithmetic processing portion.

4. A computer unit according to claim 3, including a signal gate portion provided on said up stream signal line for preventing signals from reaching.

5. A computer unit, comprising:
a plurality of connectors that accommodate multiple daughter cards;
a plurality of serial data sending lines that send serial data from each of said connectors; and
an I/O (Input/Output) bridge that sends/receives said serial data to and from said daughter cards;
wherein said plurality of serial data sending lines are integrated before connecting to said I/O bridge, and the I/O bridge receives serial data sent from any one of said daughter cards.

6. A computer unit according to claim 5, wherein said daughter cards have a feature as modem, and
sending/receiving of said serial data is made according to AC 97 (Audio CODEC) standard.

7. A computer unit according to claim 5, wherein said plurality of daughter cards include mini PCI (Peripheral Component Interconnect) cards and communication daughter cards.

8. A computer unit according to claim 5, wherein a switch for stopping sending of signals is provided on at least one of said plurality of serial data sending lines.

9. A computer unit according to claim 8, wherein a GPO line that sends designation signal for switching said switch extends from said I/O bridge to the switch.

10. A circuit board, comprising:
an arithmetic processor,
a first accommodating unit for accommodating a first expansion device;
a first signal line for sending signals from said first accommodating unit to said arithmetic processor;
a second accommodating unit for accommodating a second expansion device;
a second signal line for sending signals from said second accommodating unit to said arithmetic processor;
a recognition unit for recognizing that an expansion device has been accommodated in said second accommodating unit as said second expansion device that can process signals common to said first expansion device; and
a signal disconnecting unit for disconnecting said first or second signal line based on the recognition at said recognition unit.

11. A circuit board, comprising:
a plurality of expansion device accommodating portions capable of accommodating expansion devices;
a controlling portion for controlling said expansion devices;
a plurality of up signal transmitting lines for sending signals from said plurality of expansion device accommodating portions to said controlling portions; and
a plurality of down signal transmitting lines for sending signals from said controlling-portion to said expansion device accommodating portions;
wherein any one of said plurality of up signal transmitting lines has continuity, and all of said down signal transmitting lines have continuity.

12. A circuit board, comprising:
an arithmetic processing portion;
one channel extending from said arithmetic processing portion for sending/receiving signals according to AC 97 (Audio CODEC) standard;
a plurality of modem card accommodating portions to which said one channel connects branching; and
a switching portion provided on said one channel for switching pass state of signals from said plurality of modem card accommodating portions to said arithmetic processing portion.

13. A method for selecting an expansion device in a computer, comprising:
recognition step of recognizing that a plurality of expansion devices have been installed to the connector that can send/receive at least one common signal to and from the arithmetic processing portion;
a down signal sending step of allowing signals issued from said arithmetic processing portion to pass and send them to said plurality of expansion devices; and
an up signal sending step of selecting signals issued from any one of said plurality of expansion devices to allow them to pass, and sending them to said arithmetic processing portion.

14. A method for selecting an expansion device in a computer according to claim 13, wherein in said up signal sending step, signals from said expansion device which is connected to a connector preset to be prior are allowed to pass.

15. A method for selecting an expansion device in a computer according to claim 14, wherein in said up signal sending step, said selection of signals is made by recognizing an ID signal that is sent from an expansion device connected to a connector preset to be prior.

16. A method for selecting an expansion device in a computer according to claim 13, comprising:
display step of displaying to a user that said plurality of expansion devices have been connected; and
designation step of sending signals to a signal selector that designate expansion devices selected by said user;
wherein in said up signal sending step, signals of expansion devices are selected based on signals received in said designation step.

17. A method for selecting an expansion device in a computer according to claim 16, wherein it further has a booting step of booting said computer following said designation step.

18. A computer including:
a CPU;
a bus operatively coupled to said CPU;
a plurality of I/O devices operatively coupled to the bus;
an I/O bridge operatively coupled to said bus;
at least two expansion slots to accommodate expansion devices operatively coupled to the I/O bridge, wherein said I/O bridge includes circuits that allow common signals to flow in a first direction to the at least two expansion slots and allow signals to flow in a second direction from one of said at least two expansion slots.

19. The computer of claim 18 further including communications devices mounted in the at least two expansion slots.

20. The computer of claim 19 wherein the communications devices include modem functions.
